(19) United States
(12) Patent Application Publication
(10) Pub. No.: US 2026/0233653 A1
(43) Pub. Date: Aug. 13, 2026

(54) VEHICLE SEAT

(71) Applicant: Adient US LLC, Plymouth, MI (US)

(72) Inventors: Yunxiao LI, Yokohama-shi (JP); Motohiko OZAWA, Yokohama-shi (JP); Shiori FUJISEKI, Yokohama-shi (JP)

(73) Assignee: Adient US LLC, Plymouth, MI (US)

(21) Appl. No.: 19/453,271

(22) Filed: Jan. 20, 2026

(30) Foreign Application Priority Data
Feb. 7, 2025 (JP) 2025019067
Feb. 7, 2025 (JP) 2025019071

(51) Int. Cl. B60N 2/90; B60N 2/02

(52) U.S. Cl. CPC B60N 2/995; B60N 2/02253; B60N 2/0284

(57) ABSTRACT

A vehicle seat includes: a seat cushion including a cushion frame serving as a framework inside the seat cushion; an ottoman rotatably provided at a front portion of the cushion frame; a lift driving mechanism configured to raise and lower the front portion; and an ottoman tilting mechanism configured to rotate the ottoman in conjunction with an operation of the lift driving mechanism.

### CROSS-REFERENCE TO RELATED APPLICATIONS

The present application is based on and claims the benefit of priority from the prior Japanese Patent Application No. 2025-019067, filed on February 7, 2025, and the prior Japanese Patent Application No. 2025-019071, filed on February 7, 2025, the entire contents of which are incorporated by reference herein.

### TECHNICAL FIELD

The present disclosure relates to a vehicle seat.

### BACKGROUND

JP 2000-037255 A discloses a vehicle seat including an ottoman that is a footrest member for a seated occupant and can tilt between a storage posture and a use posture.

JP 2015-003573 A discloses a vehicle seat in which an angle of a tilt panel at a front portion of a seat cushion can be changed by a feed screw driving device.

### SUMMARY OF THE INVENTION

In the vehicle seat disclosed in JP 2000-037255 A, the ottoman tilts in conjunction with forward and backward sliding of the vehicle seat. However, in an actual use situation in a vehicle, if the lower legs of an occupant, which are free when a lift operation of lifting a front portion side of a seat cushion of a vehicle seat is performed, are supported by an ottoman, sitting becomes more comfortable, and thus improvement has been desired.

As a vehicle seat, there is a vehicle seat capable of performing a tilt operation of tilting a seat back while an angle formed with a seat surface of a seat cushion is maintained. When the seat back is reclined and the entire seat surface of the seat cushion is tilted upward in the tilt operation, the front portion side of the seat cushion becomes higher, which increases the burden on the buttocks supporting the thighs. For this reason, it has been desired that the seat surface of the seat cushion is divided into the front and rear portions, and the tilt angle of the front portion of the seat surface is maintained in the tilt operation to enable more comfortable seating. It is not preferable to apply the feed screw driving device as disclosed in JP 2015-003573 A for the tilt operation and the angle adjustment of the seat surface of the front portion of the seat cushion accompanying the tilt operation, because this makes the structure more complicated and increases the number of parts and cost.

The present disclosure is directed to a vehicle seat enabling more comfortable seating.

A vehicle seat in accordance with some embodiments includes: a seat cushion including a cushion frame serving as a framework inside the seat cushion; an ottoman rotatably provided at a front portion of the cushion frame; a lift driving mechanism configured to raise and lower the front portion; and an ottoman tilting mechanism configured to rotate the ottoman in conjunction with an operation of the lift driving mechanism.

The cushion frame may be coupled to an upper rail slidably engaged with a lower rail laid on a floor. The lift driving mechanism may include: a lift screw having one end portion rotatably supported by the upper rail, and a lift arm having one end portion coupled to the front portion of the cushion frame and the other end portion including a nut unit screwed to the lift screw and a lift motor configured to rotate the nut unit. The lift arm may be raised by a rotation of the nut unit driven by the lift motor to raise the front portion.

The ottoman tilting mechanism may be configured to: rotate the ottoman to a standing use posture according to a rising operation of the front portion of the cushion frame by the operation of the lift driving mechanism; and rotate the ottoman to a folded storage posture according to a lowering operation of the front portion of the cushion frame by the operation of the lift driving mechanism.

The ottoman may include, as a footrest member, a base plate and a slide plate slidably engaged with the base plate. In the use posture, a footrest range may be expanded relative to the storage posture with the slide plate slid and extended from the base plate.

The cushion frame may be coupled to an upper rail slidably engaged with a lower rail laid on a floor. The lift driving mechanism may include: a lift screw having one end portion rotatably supported by the upper rail, and a lift arm having one end portion coupled to the front portion of the cushion frame and the other end portion including a nut unit screwed to the lift screw and a lift motor configured to rotate the nut unit. The ottoman tilting mechanism may include: a push arm having one end portion rotatably coupled to the other end portion of the lift screw, and a slide plate rotatably coupled to the other end portion of the push arm and serving as a footrest member of the ottoman. The ottoman may be configured to be in the use posture by the lift screw rising as the lift arm is raised by a rotation of the nut unit driven by the lift motor, and the push arm pushing up the slide plate by the rising of the lift screw.

According to the above configuration, seating becomes more comfortable.

A vehicle seat in accordance with some embodiments includes: a seat cushion including a cushion frame accommodated inside the seat cushion and a seat bottom cushion serving as a seat surface; a cushion pan serving as a framework on a front portion side of the seat bottom cushion; a cushion plate coupled at a front portion of the cushion pan so as to be slidable forward; a frame tilting mechanism configured to tilt the cushion frame; and a cushion plate driving mechanism configured to slide the cushion plate in a front-rear direction in conjunction with an operation of the frame tilting mechanism.

The cushion pan may be rotatably coupled to the cushion frame, the cushion frame may be tilted by the operation of the frame tilting mechanism, and the cushion pan may be controlled such that a tilt of the cushion pan is maintained by the cushion plate driving mechanism.

The cushion plate driving mechanism may be configured to slide the cushion plate forward in a tilting operation of raising a front portion of the cushion frame.

According to the above configuration, it is possible to provide a vehicle seat capable of preventing complication in a structure and an increase in the number of parts and cost and of enabling comfortable seating.

### BRIEF DESCRIPTION OF DRAWINGS

FIG. 1A is a side view illustrating a state where an ottoman of a vehicle seat according to a first embodiment of the present invention is in a storage posture.

FIG. 1B is a side view illustrating a state where the ottoman of the vehicle seat is in a use posture.

FIG. 2A is a side view illustrating a lift driving mechanism and an ottoman tilting mechanism when the ottoman is in the storage posture.

FIG. 2B is a side view illustrating the lift driving mechanism and the ottoman tilting mechanism when the ottoman is in an intermediate posture between the storage posture and the use posture.

FIG. 2C is a side view illustrating the lift driving mechanism and the ottoman tilting mechanism when the ottoman is in the storage posture.

FIG. 3 is a perspective view of a partial cross section illustrating a rear portion of the ottoman tilting mechanism.

FIG. 4 is a partial perspective view illustrating a front portion of the ottoman tilting mechanism.

FIG. 5 is a partial perspective view illustrating a modification of the front portion of the ottoman tilting mechanism.

FIG. 6A is a side view illustrating a first posture mode of a vehicle seat according to a second embodiment of the present invention.

FIG. 6B is a side view illustrating a second posture mode of the vehicle seat.

FIG. 7A is a side view for explaining a state of a cushion plate driving mechanism in the first posture mode.

FIG. 7B is a side view for explaining a state of the cushion plate driving mechanism in the second posture mode.

FIG. 8 is a partially broken perspective view illustrating the cushion plate driving mechanism as viewed from the lower left front.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

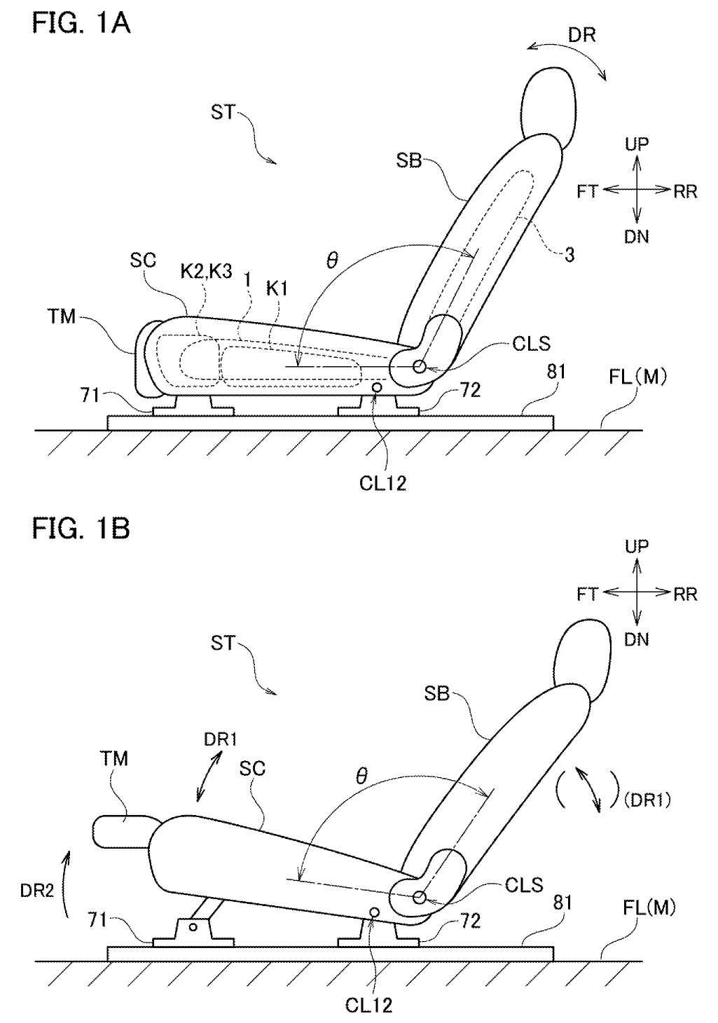

A vehicle seat according to a first embodiment of the present invention will be described with reference to a vehicle seat ST (hereinafter, a seat ST). The up-down and front-rear directions in this description are defined by the arrows illustrated in FIG. 1A. The left-right direction corresponds to the left-right direction of an occupant seated facing forward in a vehicle M; the left side is the near side in the sheet of FIG. 1A, and the right side is the far side in the sheet of FIG. 1A. This left-right direction is the width direction of the vehicle M and the seat ST. In FIGS. 1A to 5, the right direction, left direction, up direction, down direction, front direction, and rear direction are denoted by RT, LT, UP, DN, FT, and RR, respectively. In the examples described below, the vehicle M is an automobile.

As illustrated in FIG. 1A, the seat ST includes a seat cushion SC, an ottoman TM, and a seat back SB. The seat cushion SC includes a cushion frame 1 serving as a framework thereof, and upper rails 71 and 72 serving as leg portions. The cushion frame 1 incorporates a tilt driving mechanism K1, a lift driving mechanism K2, and an ottoman tilting mechanism K3. The upper rails 71 and 72 are engaged with a lower rail 81 extending in the front-rear direction laid on a floor FL of the vehicle M and are slidable in the front-rear direction. The ottoman TM is provided at a front portion of the cushion frame 1.

The seat back SB includes a back frame 3 serving as a framework inside the seat back SB, and is capable of reclining and rotating about a reclining axis CLS extending in the left-right direction (see an arrow DR in FIG. 1), which varies an angle (θ) relative to the seat cushion SC.

As illustrated in FIG. 1B, the seat ST can raise and lower a front portion of the seat cushion SC by rotating the cushion frame 1 about an axis CL10 extending in the left-right direction by operating the lift driving mechanism K2 (see an arrow DR1). FIG. 1B illustrates that the front portion of the seat cushion SC is raised in a lift operation. This lift operation can be performed by the seat cushion SC and the seat back SB integrally, without changing the reclining angle θ between the seat cushion SC and the seat back SB.

In the seat ST, the ottoman TM tilts and changes its posture according to the lift operation. Specifically, with the seat cushion SC lowered in the lift operation as illustrated in FIG. 1A, the ottoman TM is in a storage posture, in which the ottoman TM is folded along the seat cushion SC and extends in the up-down and left-right directions. In a raised state illustrated in FIG. 1B, the ottoman TM is in a standing use posture, in which the ottoman TM extends generally in the horizontal direction (see an arrow DR2).

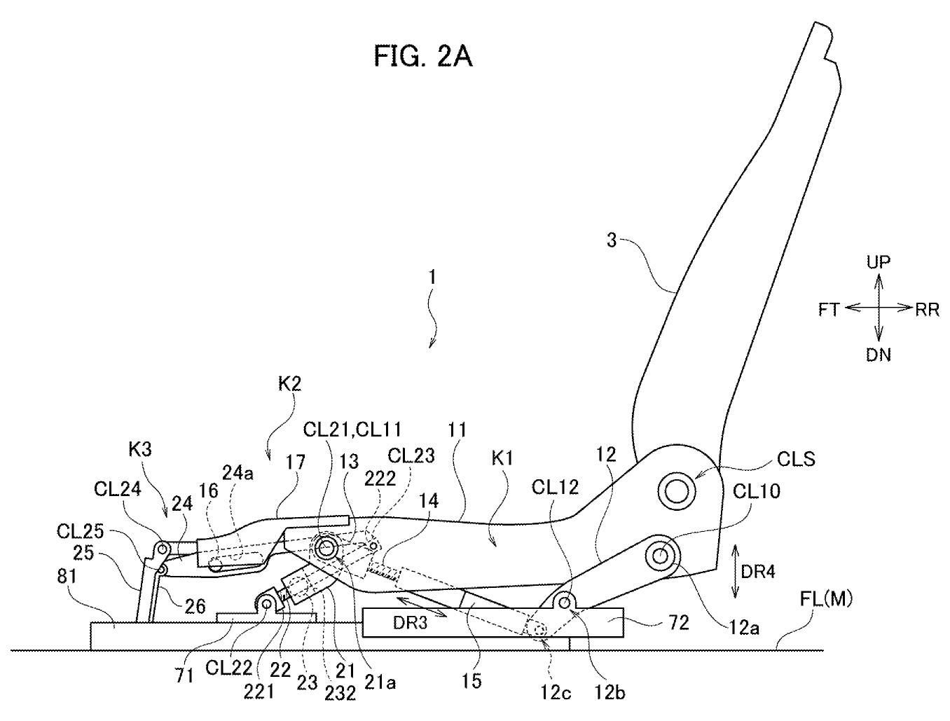

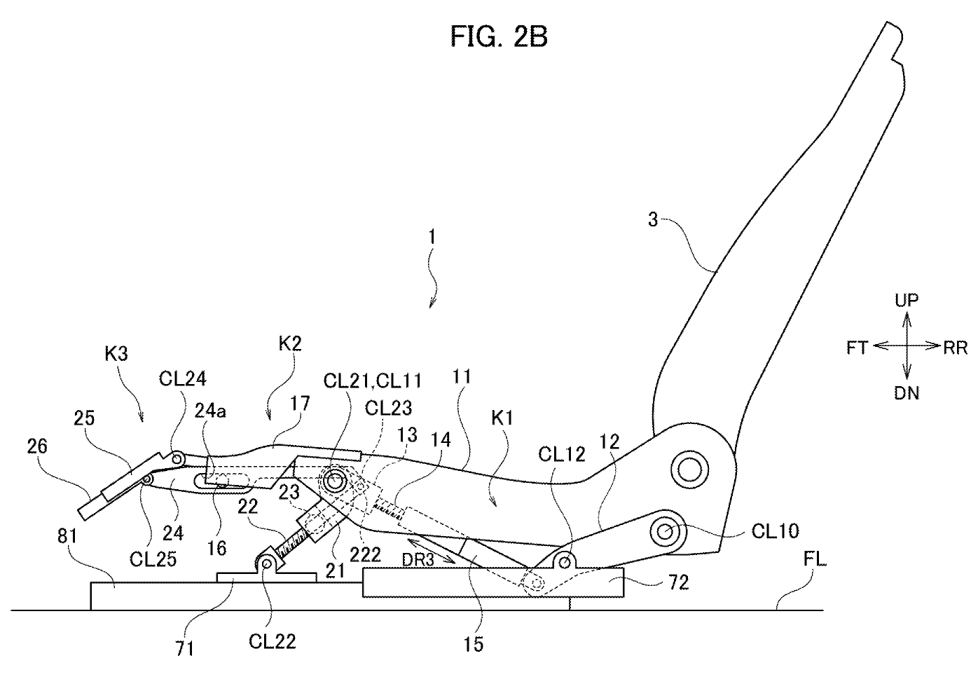

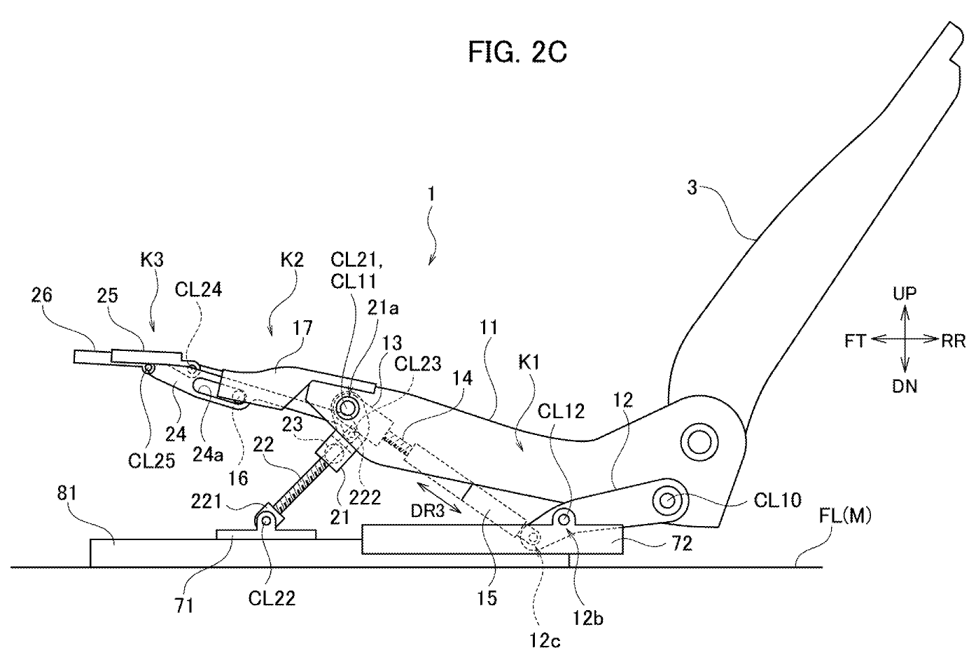

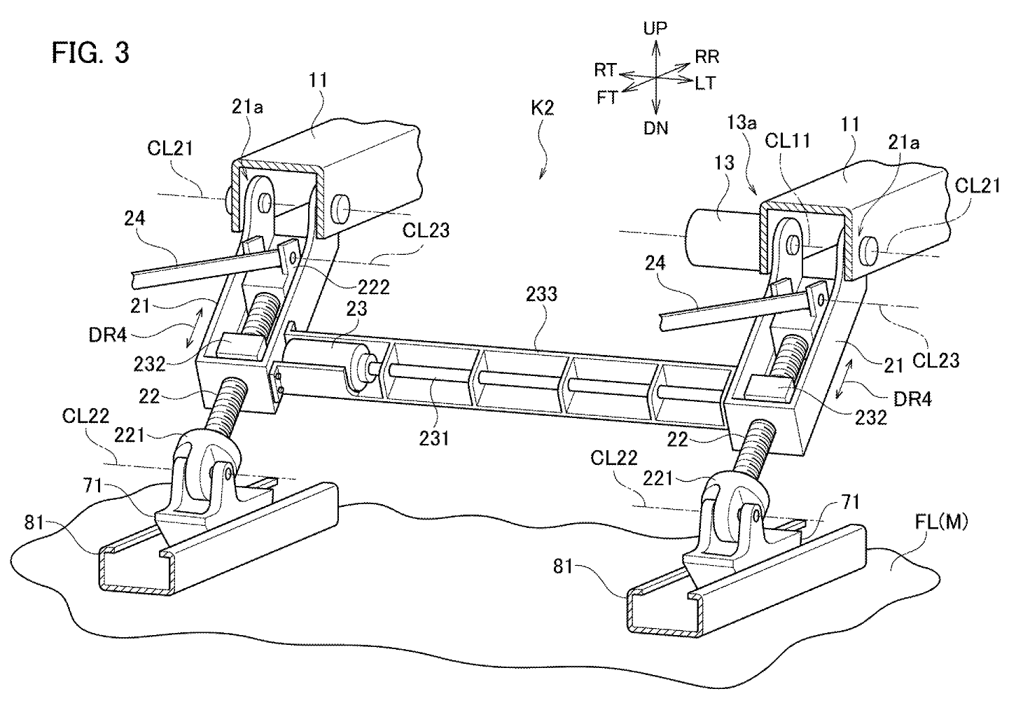

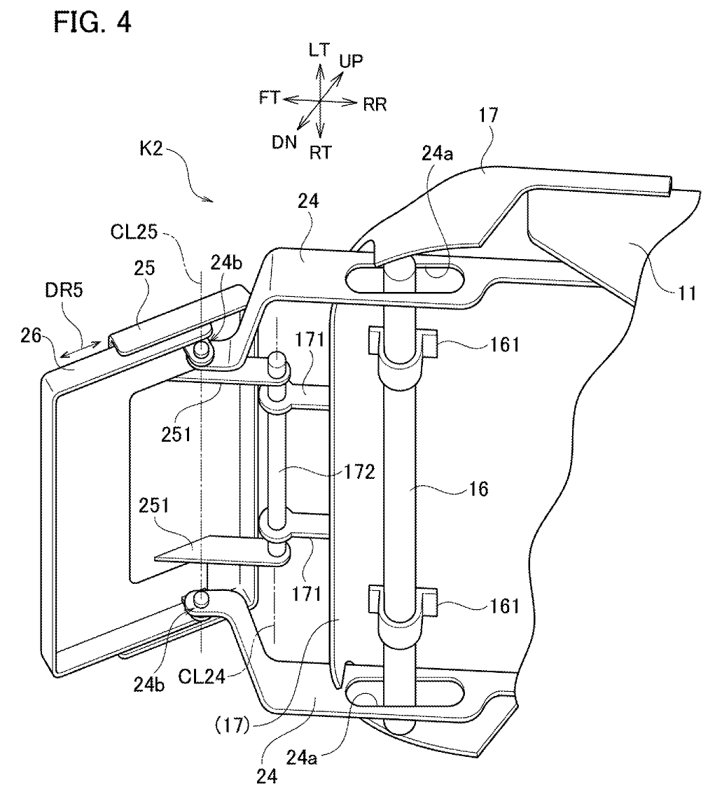

Next, the tilt driving mechanism K1, the lift driving mechanism K2, and the ottoman tilting mechanism K3 in the seat ST will be described with reference to FIGS. 2A to 2C, 3, and 4. FIG. 2A is a side view illustrating the lift driving mechanism K2 and the ottoman tilting mechanism K3 when the ottoman TM is in the storage posture. FIG. 2B is a side view illustrating the lift driving mechanism K2 and the ottoman tilting mechanism K3 when the ottoman TM is in an intermediate posture between the storage posture and the use posture. FIG. 2C is a side view illustrating the lift driving mechanism K2 and the ottoman tilting mechanism K3 when the ottoman TM is in the storage posture. FIG. 3 is a perspective view of a partial cross section illustrating a rear portion of the ottoman tilting mechanism K3. FIG. 4 is a partial perspective view illustrating a front portion of the ottoman tilting mechanism K3.

As illustrated in FIG. 2A, the tilt driving mechanism K1 includes a tilt arm 12, a tilt motor 13, a tilt screw 14, and a slide nut 15. A pair of side frames 11 extending in the front-rear direction is disposed on the left and right side portions of the cushion frame 1. A rear end portion of the tilt arm 12 is rotatably supported about an axis CL10 extending in the left-right direction at a shaft portion 12a at a rear lower portion of the left side frame 11. The tilt arm 12 extends forward and downward from the shaft portion 12a, and a shaft portion 12b is provided at an intermediate position close to a front end portion.

The shaft portion 12b rotatably supports the tilt arm 12 about an axis CL12 extending in the left-right direction relative to the upper rail 72. The slide nut 15 is rotatably coupled to a shaft portion 12c at the front end portion of the tilt arm 12, and the slide nut 15 is screwed to the tilt screw 14 extending in the front-rear direction so that its front side is higher, and moves on the tilt screw 14 by the rotation of the tilt screw 14 (see DR3). A front end of the tilt screw 14 is coupled to a drive shaft of the tilt motor 13 rotatably supported about an axis CL11 at a support portion 13a (see FIG. 3) at a front portion of each side frame 11.

With the above-described configuration, when the tilt motor 13 is operated to rotate the tilt screw 14, the slide nut 15 moves along the tilt screw 14 as indicated by the arrow DR3, which causes the tilt arm 12 to rotate about the shaft portion 12b, and the cushion frame 1 moves up and down (see an arrow DR4). That is, the operation of the tilt motor 13 causes the seat cushion SC to perform a so-called tilt operation, in which the position of the rear portion moves up and down while the position of the front portion is maintained.

Next, the lift driving mechanism K2 will be described. As illustrated in FIGS. 2A and 3, the lift driving mechanism K2 includes a lift arm 21, a lift screw 22, a lift motor 23, a shaft 231, and a nut unit 232. The lift arms 21 are provided in pairs on the left and right, and a rear end portion of each is rotatably supported about an axis CL21 extending in the left-right direction at a shaft portion 21a at a front portion of the side frame 11. The nut unit 232 is fixed to a front end portion of each lift arm 21.

The lift screw 22 is screwed into the nut unit 232 so that its rear side is higher. A front end portion (one end portion) of the lift screw 22 is rotatably supported by the upper rail 71 about an axis CL22 extending in the left-right direction via a screw holder 221.

As illustrated in FIG. 3, the drive shaft of the lift motor 23 is coupled to the right side nut unit 232, and a shaft 231 coupled to the drive shaft of the lift motor 23 is coupled to the left side nut unit 232. As a result, the portion of the nut unit 232 screwed to the lift screw 22 rotates according to the rotational operation of the lift motor 23, and the left and right lift arms 21 move along the lift screw 22 in conjunction with the rotation (see the arrow DR4 in FIG. 3). The lift motor 23 and the shaft 231 are supported by a supporter 233 coupling the pair of lift arms 21.

The operation of the lift driving mechanism K2 will be described with reference to FIGS. 2A to 2C. FIG. 2A illustrates a state where the nut unit 232 is positioned at the lowermost side of the lift screw 22. This is a state where the cushion frame 1, that is, the seat cushion SC is lowered at the lowest position. On the other hand, FIG. 2C illustrates a state where the nut unit 32 is positioned at the uppermost side of the lift screw 22. This is a state where the seat cushion SC is raised at the uppermost position. FIG. 2B illustrates an intermediate position between the lowermost position and the uppermost position.

As illustrated in FIGS. 2A to 2C, when the lift motor 23 is rotated in a prescribed direction, the shaft portion 21a coupling the lift arm 21 and the side frame 11 is raised, and the side frame 11 rotates clockwise about the shaft portion 12b. That is, this is the lift operation in which the front portion of the seat cushion SC rises.

The ottoman tilting mechanism K3 is coupled and disposed to operate in conjunction with the lift driving mechanism K2 described above. The ottoman tilting mechanism K3 includes a coupling portion 222, a push arm 24, a base plate 25, a slide plate 26, a guide shaft 16, and a support frame 17.

As illustrated in FIGS. 2A and 3, the coupling portion 222 is fixed to a rear end portion (the other end portion) of each of the pair of lift screws 22, and rotatably supports a rear end portion of the push arm 24 about an axis CL23 extending in the left-right direction. As illustrated in FIG. 4, a pair of the push arms 24 extends forward and in generally parallel, and is bent so as to approach each other at the front portion, and their tip portions are parallel again and each have a shaft portion 24b. A long hole 24a extending in the front-rear direction is formed in a central portion of each push arm 24 in the front-rear direction.

The support frame 17 is a plate-like member coupling the front portions of the pair of left and right side frames 11, and a pair of shaft holders 161 holding a guide shaft 16 in a posture extending in the left-right direction is fixed to a front lower surface of the support frame 17. In addition, a pair of support arms 171 supporting a support shaft 172 in a posture extending in the left-right direction is fixed to a front portion of the support frame 17 so as to extend forward.

The guide shaft 16 is inserted through the long hole 24a of each of the pair of push arms 24. As a result, the push arms 24 are allowed to move only in the extending direction of the push arms 24 (the front-rear direction in FIG. 4). The shaft portion 24b provided at the tip end of each push arm 24 rotatably supports the slide plate 26 about an axis CL25 extending in the left-right direction. The slide plate 26 is slidable in the front-rear direction (see an arrow DR5) relative to the base plate 25 by an engagement structure (not illustrated).

According to the operation of the lift driving mechanism K2 configured as described above, the ottoman tilting mechanism K3 performs the following operations. At the lowermost position of the cushion frame 1 illustrated in FIG. 2A, the lift motor 23 is rotated in a prescribed direction to raise the pair of lift arms 21. Accordingly, as illustrated in FIGS. 2B to 2C, the rear portions of the lift screws 22 rise, and the positions of the coupling portions 222 fixed to the rear end move forward while drawing a rotation locus. Since the rear ends of the push arms 24 are coupled to the coupling portions 222, the push arms 24 are pushed and moved forward by the coupling portions 222. This movement is guided in one direction (forward direction) by engagement between the long holes 24a and the guide shaft 16.

At the lowermost position of the cushion frame 1, the position of the guide shaft 16 in the long holes 24a is at the foremost position, and moves rearward as the lift operation proceeds. The position of the guide shaft 16 is at the intermediate position of the long holes 24a in the intermediate position illustrated in FIG. 2B, and is at the rearmost position in the uppermost position illustrated in FIG. 2C.

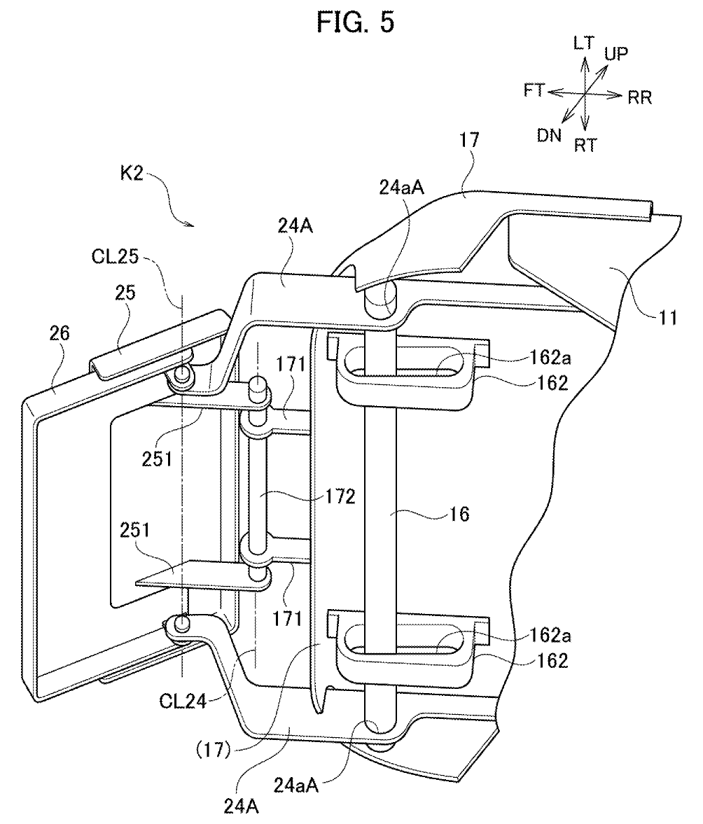

When the push arms 24 are pushed forward by the coupling portions 222, the slide plate 26 rotatably coupled to the shaft portions 24b at the tip end of the push arms 24 is pushed forward. The slide plate 26 is slidable relative to the base plate 25, and a pair of support arms 251 of the base plate 25 extending rearward from the base plate 25 in FIG. 5 are supported by the support shaft 172 so that the support arms 251 are rotatable but immovable back and forth. Therefore, the base plate 25 rotates to a generally horizontal position so as to be lifted about the axis CL24 along with forward movement at the shaft portion 24b of the slide plate 26. With this operation, the base plate 25 and the slide plate 26, which are footrest members of the ottoman TM, are in the standing use posture.

The slide plate 26 also slides while rotating following the base plate 25, and extends forward according to the forward movement amount of the shaft portion 24b. That is, the base plate 25 and the slide plate 26 extend forward longer in the use posture than in the storage posture, and the footrest range can be expanded to support the lower legs of the occupant with a wider area. The base plate 25 and the slide plate 26 are covered with a flexible cushion material or the like to provide a good footrest feel.

By reversely rotating the lift motor 23 from the uppermost position of the cushion frame 1 illustrated in FIG. 2C, a lowering operation opposite to the above-described rising operation is performed, and the ottoman TM constituted by the base plate 25 and the slide plate 26 is brought into the storage posture in which the length is shortened as illustrated in FIG. 2A through the intermediate position illustrated in FIG. 2B.

As described above in detail, in the vehicle seat ST, the ottoman TM is rotated and raised in conjunction with the lift operation of the seat cushion SC performed by raising and lowering the front portion of the cushion frame 1. Then, when the front portion of the seat cushion SC is lifted and the lower legs are free, the ottoman TM automatically rises and functions as a member on which the lower legs are placed, which enables more comfortable seating.

The guide structure constituted by the guide shaft 16 of the push arms 24 may be a modification illustrated in FIG. 5, instead of the above-described configuration. In this modification, push arms 24 A are used instead of the push arms 24, and shaft holders 162 are used instead of the shaft holders 161 for the guide shaft 16. The push arms 24A and the guide shaft 16 are engaged by round holes 24aA instead of the long holes, and the movement of the guide shaft 16 in the front-rear direction caused by this engagement is allowed by inserting the guide shaft 16 into long holes 162a formed in the shaft holders 162.

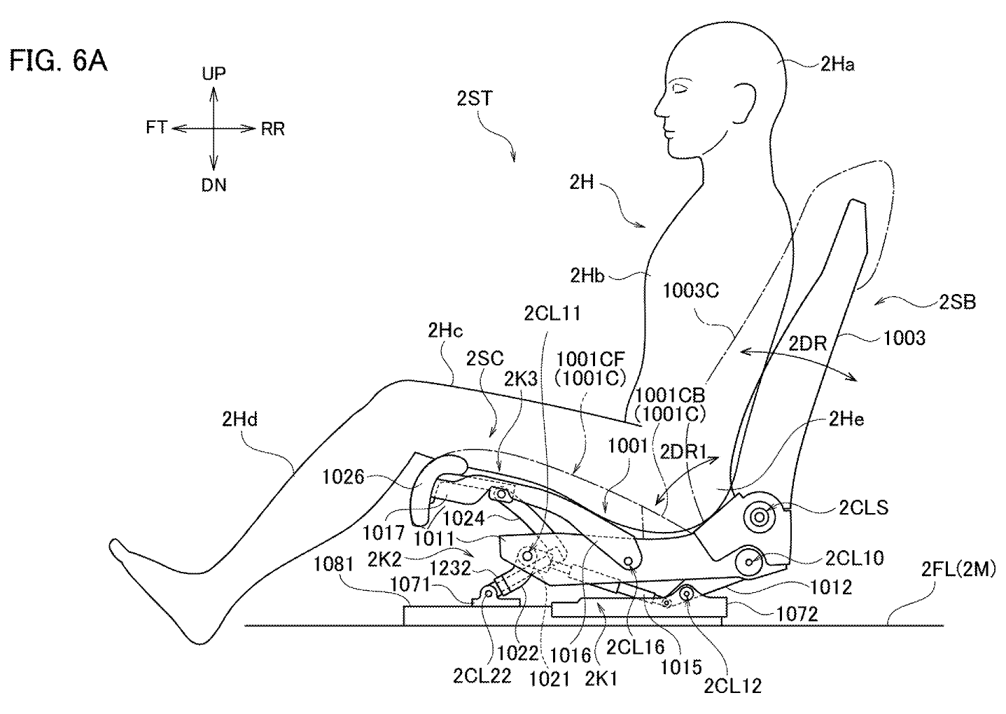

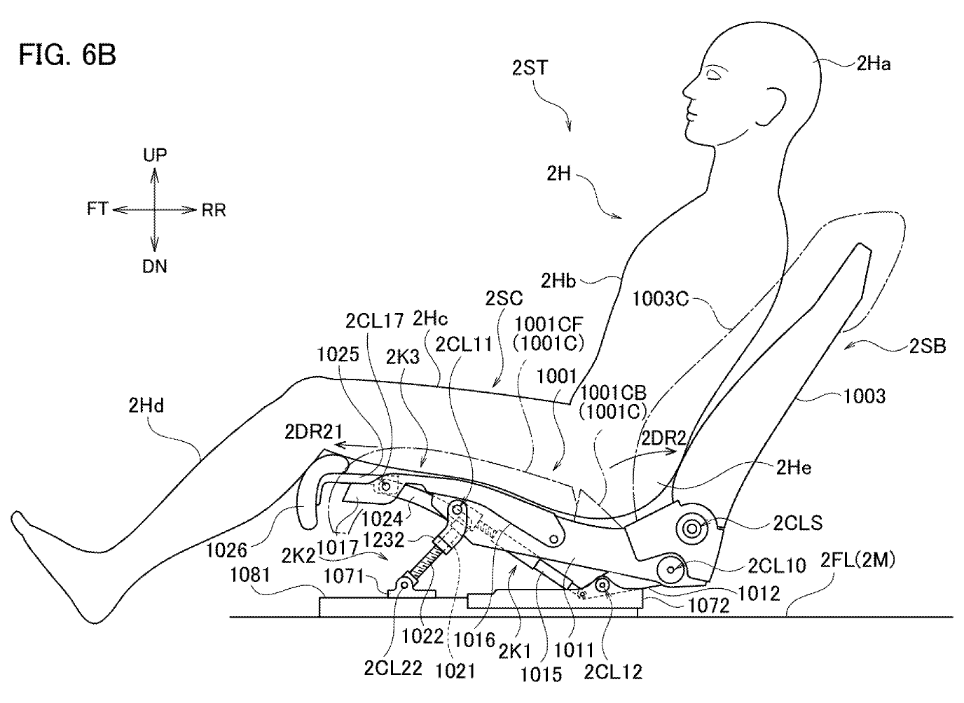

A vehicle seat according to a second embodiment of the present invention will be described with reference to a vehicle seat 2ST (hereinafter, a seat 2ST). First, an outline of the seat 2ST will be described with reference to FIGS. 6A and 6B. FIG. 6A is a side view illustrating a first posture mode of the vehicle seat 2ST according to an aspect of the present invention. FIG. 6B is a side view illustrating a second posture mode of the vehicle seat.

The up-down and front-rear directions in the following description are defined by the arrows illustrated in FIG. 6A. The left-right direction corresponds to the left-right direction of an occupant seated facing forward in a vehicle 2M; the left side is the near side in the sheet of FIG. 6A, and the right side is the far side in the sheet of FIG. 6A. This left-right direction is the width direction of the vehicle 2M and the seat 2ST. In FIGS. 6A to 8, the right direction, left direction, up direction, down direction, front direction, and rear direction are denoted by RT, LT, UP, DN, FT, and RR, respectively. In the examples described below, the vehicle 2M is an automobile.

As illustrated in FIGS. 6A and 6B, the seat 2ST includes a seat cushion 2SC, a seat back 2SB, and a support cushion 1026. The seat cushion 2SC includes a cushion frame 1001 serving as a framework thereof, and upper rails 1071 and 1072 serving as leg portions. The cushion frame 1001 incorporates a lift driving mechanism 2K1, a frame tilting mechanism 2K2, and a cushion plate driving mechanism 2K3. The upper rails 1071 and 1072 are engaged with a lower rail 1081 extending in the front-rear direction laid on a floor 2FL of the vehicle 2M and are slidable in the front-rear direction. The support cushion 1026 is provided at a front portion of the cushion frame 1001.

The seat back 2SB includes a flexible back cushion 1003C indicated by a long dashed dotted line, and a back frame 1003 serving as a framework accommodated in the back cushion 1003C. The seat back 2SB is capable of reclining and rotating about a reclining axis 2CLS extending in the left-right direction (see an arrow 2DR in FIG. 6A), which varies an angle formed with the seat cushion 2SC.

The seat 2ST can perform a tilt operation of integrally rotating the cushion frame 1001 and the back frame 1003 about an axis 2CL10 extending in the left-right direction by operating the frame tilting mechanism 2K2 (see an arrow 2DR1 in FIG. 6A). FIG. 6B illustrates a second posture mode in which the cushion frame 1001 and the back frame 1003 are rotated clockwise from the first posture mode illustrated in FIG. 6A by this tilt operation (see an arrow 2DR2).

In the seat 2ST, a flexible seat bottom cushion 1001C (indicated by a long dashed dotted line in FIGS. 6A and 6B) covering the cushion frame 1001 is divided into a front cushion 1001CF including a front portion and a rear cushion 1001CB including a rear portion. A framework of the front cushion 1001CF is a cushion pan 1017 (details of which will be described later), and a framework of the rear cushion 1001CB is a side frame 1011.

In the seat 2ST, when the seat back 2SB is tilted rearward from the first posture mode toward the second posture mode (see the arrow 2DR2), the rear cushion 1001CB is tilted together with the seat back 2SB, while the tilt angle of the front cushion 1001CF is generally maintained, and the support cushion 1026 extends forward to expand the seat surface (see an arrow 2DR21).

When the seat back 2SB is tilted rearward in a mode change from the first posture mode to the second posture mode, an occupant 2H seated on the seat 2ST is brought into a relaxed posture since a head 2Ha and a body 2Hb above buttocks 2He are tilted rearward. At this time, thighs 2Hc are not raised more than necessary and continues to be supported by the front cushion 1001CF. Therefore, the burden on the buttocks 2He supporting the thighs 2Hc is reduced.

In addition, since the support cushion 1026 supports the tip end sides of the thighs 2Hc and extends forward so as to come into contact with the calves of the lower legs 2Hd, the area of the seat surface on which the thighs 2Hc are placed is expanded. Therefore, the reaction force from the seat cushion 2SC received by the thighs 2Hc is dispersed to reduce the reaction force per unit area, and the occupant 2H can more comfortably sit on the seat 2ST.

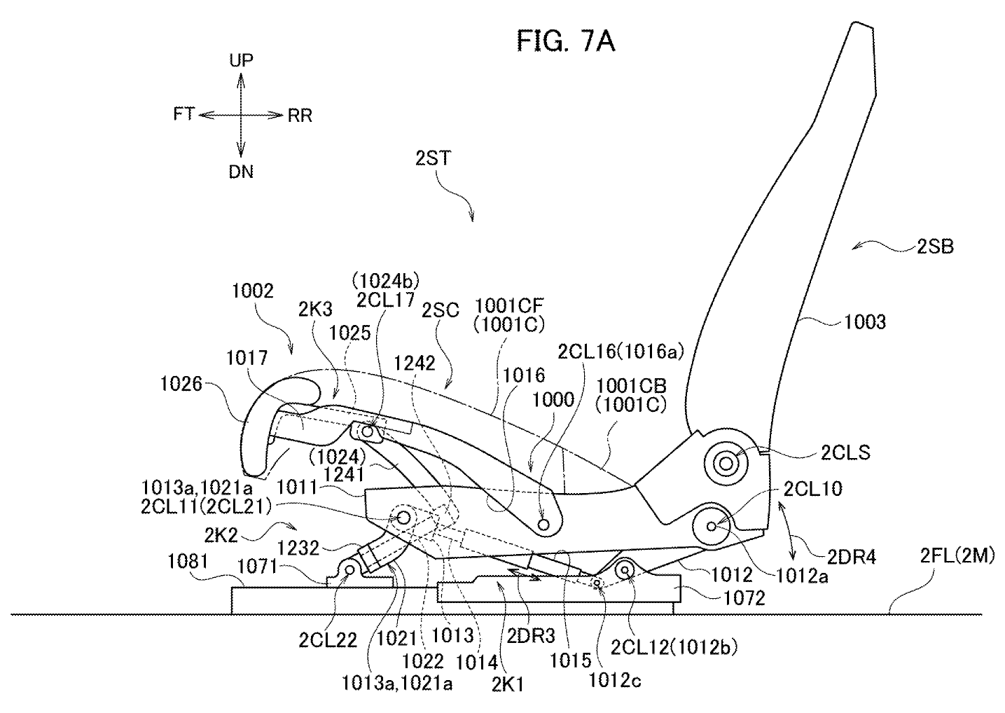

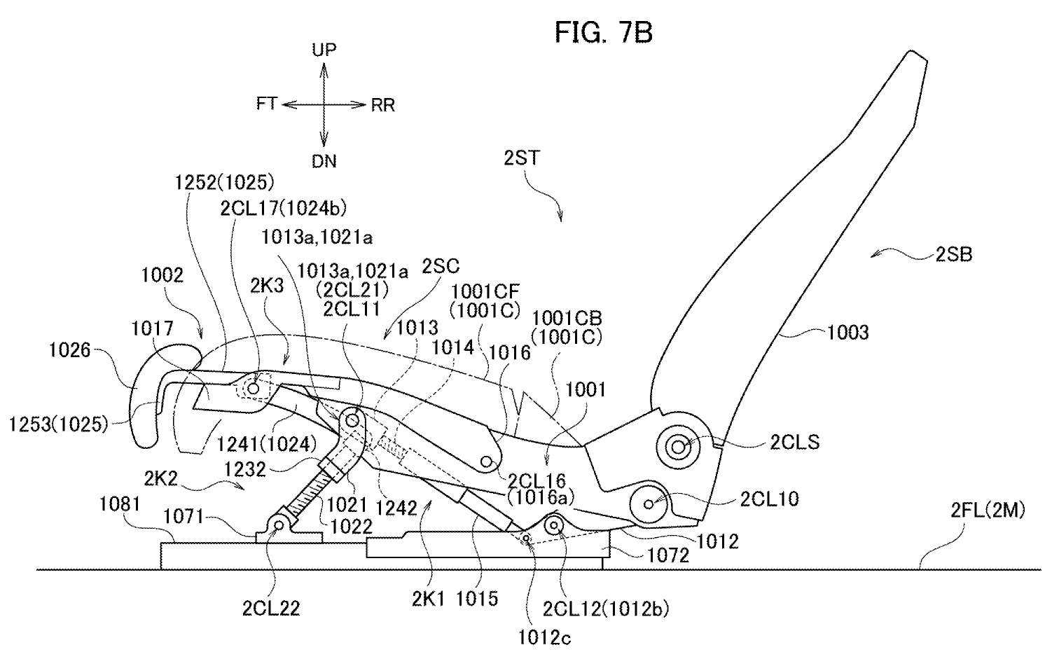

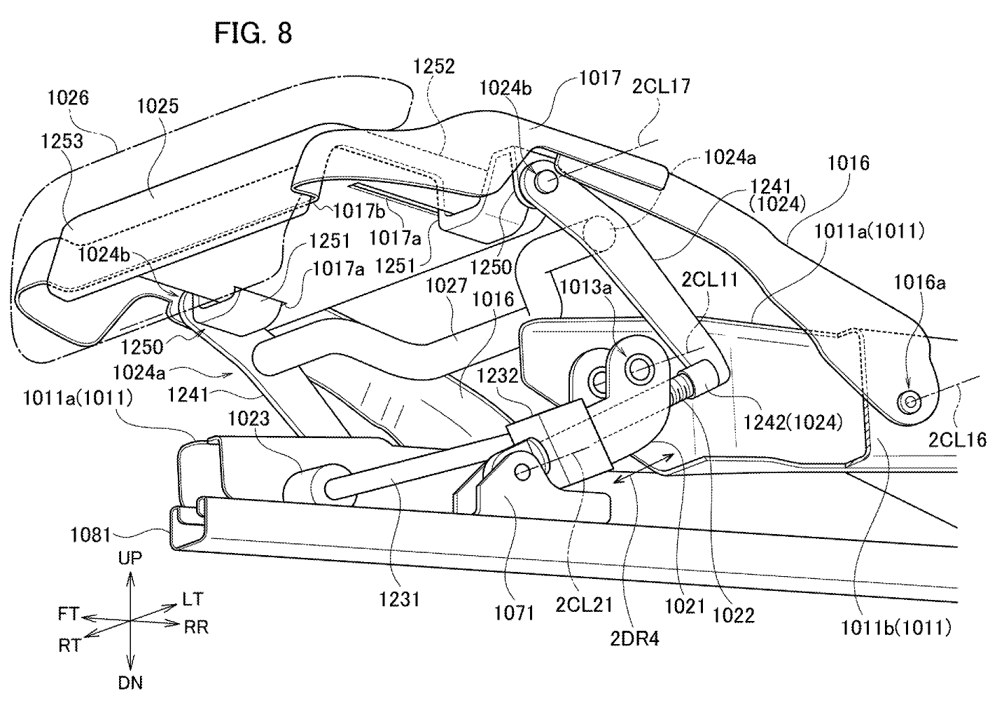

Next, detailed structures of the lift driving mechanism 2K1, the frame tilting mechanism 2K2, and the cushion plate driving mechanism 2K3 in the seat 2ST will be described with reference to FIGS. 7A, 7B, and 8. FIG. 7A is a side view for explaining a state of the cushion plate driving mechanism 2K3 in the first posture mode. FIG. 7B is a side view for explaining a state of the cushion plate driving mechanism 2K3 in the second posture mode. FIG. 8 is a partially broken perspective view illustrating the cushion plate driving mechanism 2K3 as viewed from the lower left front.

As illustrated in FIGS. 7A and 7B, the lift driving mechanism 2K1 includes a lift arm 1012, a lift motor 1013, a lift screw 1014, and a slide nut 1015. A pair of side frames 1011 extending in the front-rear direction is disposed on the left and right side portions of the cushion frame 1001. A rear end portion of the lift arm 1012 is rotatably supported about the axis 2CL10 extending in the left-right direction at a shaft portion 1012a at a rear portion of the left side frame 1011. The lift arm 1012 extends forward and downward from the shaft portion 1012a, and a shaft portion 1012b is provided at an intermediate position close to a front end portion.

The lift arm 1012 is rotatably supported by the upper rail 1072 about the axis 2CL12 extending in the left-right direction at the shaft portion 1012b. A slide nut 1015 is rotatably coupled to a shaft portion 1012c at the front end portion of the lift arm 1012. The slide nut 1015 is screwed to the lift screw 1014, which is higher at the front and extended in the front-rear direction, and moves on the lift screw 1014 by the rotation of the lift screw 1014 (see an arrow 2DR3). A front end of the lift screw 1014 is coupled to a drive shaft of the lift motor 1013. The lift motor 1013 is rotatably supported about an axis 2CL11 extending in the left-right direction at a support portion 1013a at a front portion of each side frame 1011. As illustrated in FIG. 8, the side frame 1011 is configured by combining an inner frame 1011a on the inner side and an outer frame 1011b on the outer side. The lift arm 1012, the lift screw 1014, and the like are accommodated and disposed between the inner frame 1011a and the outer frame 1011b.

With the above-described configuration, when the lift motor 1013 is operated to rotate the lift screw 1014, the slide nut 1015 moves along the lift screw 1014 as indicated by the arrow 2DR3, and thus, the lift arm 1012 rotates about the shaft portion 1012b, and the cushion frame 1001 moves up and down (see an arrow 2DR4). That is, the operation of the lift motor 1013 causes the position of the rear portion of the seat cushion 2SC to move up and down while the height of the front portion is maintained.

Next, the frame tilting mechanism 2K2 will be described. As illustrated in FIGS. 7A, 7B, and 8, the frame tilting mechanism 2K2 includes a tilt arm 1021, a tilt screw 1022, a tilt motor 1023, a shaft 1231, and a nut unit 1232. The tilt arms 1021 are provided in pairs on the left and right, and a rear end portion of each is rotatably supported about an axis 2CL21 extending in the left-right direction at a shaft portion 1021a at the front portion of the side frame 1011. The nut unit 1232 is fixed to a front end portion of each tilt arm 1021.

The tilt screw 1022 is screwed into the nut unit 1232 so that its rear side is higher. A front end portion of the tilt screw 1022 is rotatably supported by the upper rail 1071 about an axis 2CL22 extending in the left-right direction.

As illustrated in FIG. 8, the shaft 1231 coupled to a drive shaft of the tilt motor 1023 is coupled to the nut unit 1232. As a result, the portion of the nut unit 1232 screwed to the tilt screw 1022 rotates according to the rotational operation of the tilt motor 1023, and the tilt arm 1021 moves along the tilt screw 1022 (see the arrow 2DR4).

In the above-described first posture mode, the nut unit 1232 is positioned at the lowermost position in the movement range on the tilt screw 1022, and in the second posture mode, the nut unit 1232 is positioned at the uppermost position in the movement range on the tilt screw 1022.

When the tilt motor 1023 is rotated in a prescribed direction in the first posture mode, the nut unit 1232 is raised toward the second posture mode, and the shaft portion 1021a coupling the tilt arm 1021 and the side frame 1011 is raised, and the side frame 1011 rotates clockwise about the shaft portion 1012b. That is, the side frame 1011 rotates so that the front portion side rises.

The cushion plate driving mechanism 2K3 is coupled and disposed so as to operate in conjunction with the frame tilting mechanism 2K2. The cushion plate driving mechanism 2K3 includes a pan holder 1016, a cushion pan 1017, a cushion arm 1024, a cushion plate 1025, a support cushion 1026, and a coupling bar 1027 (see FIG. 8).

The pan holders 1016 provided in pairs on the left and right are plate-shaped members disposed in a posture extending lengthwise in the front-rear direction, and a rear end portion of each is rotatably supported about an axis 2CL16 extending in the left-right direction at a shaft portion 1016a at a center position of the side frame 1011 in the front-rear direction. The cushion pan 1017 is fixed so as to straddle the front portions of the pair of left and right pan holders 1016 and is integrated with the pan holders 1016. As illustrated in FIG. 8, the cushion pan 1017 is formed with a pair of left and right guide slits 1017a extending lengthwise in the front-rear direction.

As illustrated in FIGS. 7B and 8, the cushion plate 1025 includes a flat base portion 1252 and a bent portion 1253 bent downward from a front end of the base portion 1252, and is formed in an L shape in a side view. As illustrated in FIG. 8, a plate-like protruding piece 1250 protruding downward and an engaging piece portion 1251 protruding downward and then folded back are formed on a lower surface of the base portion 1252.

The protruding piece 1250 is coupled to a plate coupling portion 1024b at a front end portion of the cushion arm 1024 so as to be rotatable about an axis 2CL17 extending in the left-right direction, and the engaging piece portion 1251 is engaged within the guide slit 1017a of the cushion pan 1017. With these, the cushion plate 1025 slides in the front-rear direction along the cushion pan 1017. The support cushion 1026 is a flexible cushion member attached so as to cover at least an outer surface of the cushion plate 1025.

The cushion arm 1024 includes a base portion 1241 formed in an elongated plate shape and disposed in a posture extending in the front-rear direction, and a screw holder 1242 formed at a rear end portion of the base portion 1241. The screw holder 1242 is fixed to the upper end of the tilt screw 1022, and the front tip portion of the base portion 1241 is rotatably coupled to the plate coupling portion 1024b relative to the protruding piece 1250 of the cushion plate 1025 as described above. As a result, the cushion arm 1024 is disposed in a tilted posture in which the front tip end portion is higher, and the position of the front tip end portion changes according to the tilt change of the tilt screw 1022 caused by the movement of the nut unit 1232.

As illustrated in FIG. 8, the coupling bar 1027 is fixed to the pair of left and right cushion arms 1024 at bar coupling portions 1024a. As a result, the pair of cushion arms 1024 operates in conjunction with each other.

The frame tilting mechanism 2K2 and the cushion plate driving mechanism 2K3 described above operate in conjunction by the rotational operation of the tilt motor 1023 alone. Specifically, description will be given by a mode changing operation from the first posture mode illustrated in FIG. 7A to the second posture mode illustrated in FIG. 7B.

In the first posture mode in which the nut unit 1232 is at the lowermost position, when the tilt motor 1023 rotates in a prescribed direction and the rotation is transmitted to the nut unit 1232 via the shaft 1231, the nut unit 1232 rises on the screwed tilt screw 1022. Accordingly, the tilt arm 1021 to which the nut unit 1232 is fixed is raised, and the side frame 1011 pivotally supporting the tilt arm 1021 at the shaft portion 1021a is lifted.

Here, since the lift driving mechanism 2K1 is not operated, the side frame 1011 rotates clockwise in FIG. 7A about the axis 2CL12. Therefore, the locus of the shaft portion 1021a becomes arcuate, and the tilt screw 1022 rises counterclockwise about the axis 2CL22 as the nut unit 1232 rises. As a result, the cushion arm 1024 fixed to the tip end of the tilt screw 1022 moves integrally with the tilt screw 1022, and the plate coupling portion 1024b at the tip end of the cushion arm 1024 moves forward on the arcuate trajectory about the axis 2CL22 by a distance longer than the upward movement distance. Therefore, the cushion plate 1025 coupled to the plate coupling portion 1024b is pushed substantially forward. At this time, the cushion pan 1017 supporting the cushion plate 1025 so as to be slidable and engageable and the pan holder 1016 integrated with the cushion pan 1017 are rotatable about the axis 2CL16 but generally maintain the tilt angle to allow the forward movement of the cushion plate 1025. That is, the tilt angle of the front cushion 1001CF having the cushion pan 1017 as the framework is generally maintained, and the support cushion 1026 attached to the cushion plate 1025 extends forward.

As illustrated in FIG. 8, a recessed portion 1017b, where a central portion is recessed rearward, is formed at a front end portion of the cushion pan 1017, and the cushion plate 1025 comes into the recessed portion 1017b in the first posture mode. As a result, in the first posture mode, the outer shapes of the support cushion 1026 and the front cushion 1001CF are continuous and have no protruding portion, and the appearance quality is improved.

As described above, in one aspect of the vehicle seat of the present invention, the rear cushion 1001CB on the rear portion side of the seat bottom cushion 1001C is tilted so as to be lifted while the angle formed with the seat back 2SB is maintained, by the tilt operation from the first posture mode illustrated in FIG. 7A to the second posture mode illustrated in FIG. 7B (see the arrow 2DR2 in FIG. 6B). That is, the cushion pan 1017 is rotatably coupled to the cushion frame 1001, the cushion frame 1001 is tilted by the operation of the frame tilting mechanism 2K2, and the cushion pan 1017 is controlled such that the tilt is maintained by the cushion plate driving mechanism 2K3. Therefore, in the tilt operation in which the front portion of the cushion frame 1001 rises, the front cushion 1001CF having the cushion pan 1017 as the framework generally maintains the first posture mode. On the other hand, the support cushion 1026 extends forward and the seat surface is substantially expanded by the control of the cushion plate driving mechanism 2K3.

As a result, in the second posture, the burden on the buttocks 2He for supporting the thighs 2Hc of the seated occupant 2H can be reduced, and the occupant 2H can be seated more comfortably. In addition, the tilt operation and the operation in which the support cushion 1026 extends forward can be performed in conjunction with each other by the operation of the tilt motor 1023 alone. As a result, the operation of the cushion plate driving mechanism 2K3 in which the support cushion 1026 moves in and out can be performed without an additional motor, which prevents complication in the structure and an increase in the number of parts and cost.

The vehicles M and 2M include not only vehicles such as automobiles and railway vehicles, but also ships, airplanes, and flying bodies such as drones, and mean moving bodies that move with people onboard. In addition, the directions of the up, down, left, right, front, and rear in the above description are directions as examples defined for convenience of description, and the orientations of the seats ST and 2ST with respect to the vehicle are not defined and are free.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

1. A vehicle seat comprising:
a seat cushion including a cushion frame serving as a framework inside the seat cushion;
an ottoman rotatably provided at a front portion of the cushion frame;
a lift driving mechanism configured to raise and lower the front portion; and
an ottoman tilting mechanism configured to rotate the ottoman in conjunction with an operation of the lift driving mechanism.

2. The vehicle seat according to claim 1, wherein
the cushion frame is coupled to an upper rail slidably engaged with a lower rail laid on a floor, and
the lift driving mechanism includes:
a lift screw having one end portion rotatably supported by the upper rail, and
a lift arm having one end portion coupled to the front portion of the cushion frame and the other end portion including a nut unit screwed to the lift screw and a lift motor configured to rotate the nut unit, and
the lift arm is raised by a rotation of the nut unit driven by the lift motor to raise the front portion.

3. The vehicle seat according to claim 1, wherein the ottoman tilting mechanism is configured to:
rotate the ottoman to a standing use posture according to a rising operation of the front portion of the cushion frame by the operation of the lift driving mechanism; and
rotate the ottoman to a folded storage posture according to a lowering operation of the front portion of the cushion frame by the operation of the lift driving mechanism.

4. The vehicle seat according to claim 3, wherein
the ottoman includes, as a footrest member, a base plate and a slide plate slidably engaged with the base plate, and
in the use posture, a footrest range is expanded relative to the storage posture with the slide plate slid and extended from the base plate.

5. The vehicle seat according to claim 3, wherein
the cushion frame is coupled to an upper rail slidably engaged with a lower rail laid on a floor,
the lift driving mechanism includes:
a lift screw having one end portion rotatably supported by the upper rail, and
a lift arm having one end portion coupled to the front portion of the cushion frame and the other end portion including a nut unit screwed to the lift screw and a lift motor configured to rotate the nut unit,
the ottoman tilting mechanism includes:
a push arm having one end portion rotatably coupled to the other end portion of the lift screw, and
a slide plate rotatably coupled to the other end portion of the push arm and serving as a footrest member of the ottoman, and
the ottoman is configured to be in the use posture by the lift screw rising as the lift arm is raised by a rotation of the nut unit driven by the lift motor, and the push arm pushing up the slide plate by the rising of the lift screw.

6. A vehicle seat comprising:
a seat cushion including a cushion frame accommodated inside the seat cushion and a seat bottom cushion serving as a seat surface;
a cushion pan serving as a framework on a front portion side of the seat bottom cushion;
a cushion plate coupled at a front portion of the cushion pan so as to be slidable forward;
a frame tilting mechanism configured to tilt the cushion frame; and
a cushion plate driving mechanism configured to slide the cushion plate in a front-rear direction in conjunction with an operation of the frame tilting mechanism.

7. The vehicle seat according to claim 6, wherein
the cushion pan is rotatably coupled to the cushion frame,
the cushion frame is tilted by the operation of the frame tilting mechanism, and
the cushion pan is controlled such that a tilt of the cushion pan is maintained by the cushion plate driving mechanism.

8. The vehicle seat according to claim 6, wherein the cushion plate driving mechanism is configured to slide the cushion plate forward in a tilting operation of raising a front portion of the cushion frame.
